(19) United States
(12) Patent Application Publication
(10) Pub. No.: US 2023/0078555 A1
(43) Pub. Date: Mar. 16, 2023

(54) A METHOD FOR DETERMINING THE FLAME SHAPE OF A SWIRLING FLAME IN A CLOSED COMBUSTION CHAMBER

(71) Applicant: BUDAPESTI MÜSZAKI ÉS GAZDASÁGTUDOMÁNYI EGYETEM, BUDAPEST (HU)

(72) Inventors: VIKTOR JÓZSA, DIÓSJENÕ (HU); ATTILA KUN-BALOG, HÓDMEZÕVÁSÁRHELY (HU)

(21) Appl. No.: 17/801,030

(22) PCT Filed: Feb. 5, 2021
(86) PCT No.: PCT/HU2021/050010

§ 371 Date: Aug. 19, 2022

(30) Foreign Application Priority Data
Feb. 20, 2020 (HU) P2000063

(51) Int. Cl. F23N 5/16; G01H 3/08; G01H 3/12

(52) U.S. Cl. CPC F23N 5/16; G01H 3/08; G01H 3/12; F23N 2223/10

(57) ABSTRACT

The subject of the present patent is a method to determine the flame shape of a swirling flame in a steady-operating burner in a closed combustion chamber. The broadband combustion noise of the burner is sensed inside the combustion chamber, and the spectrum and the sound pressure levels are calculated from the acoustic vibrations of the process. The conclusions are made on this data to determine the flame shape. To determine the governing frequencies, the burner is investigated at various operating conditions. At least one parameter from the fuel flow rate, combustion air flow rate, and the swirl number is varied in the physically accessible range of the burner. The spectrum is divided into 0-500 Hz, 501-2000 Hz, and 2 kHz-6 kHz frequency ranges, then the amplitudes at the band center frequencies are calculated. Based on either the temporal analysis of band center frequencies or the temporal variation of their ratio or the two combined, the shape of the swirling flame can be determined.

The invention relates to a method according to the preamble of claim 1 for determining the flame shape of a swirling flame in a closed combustion chamber, using third-octave band acoustic analysis.

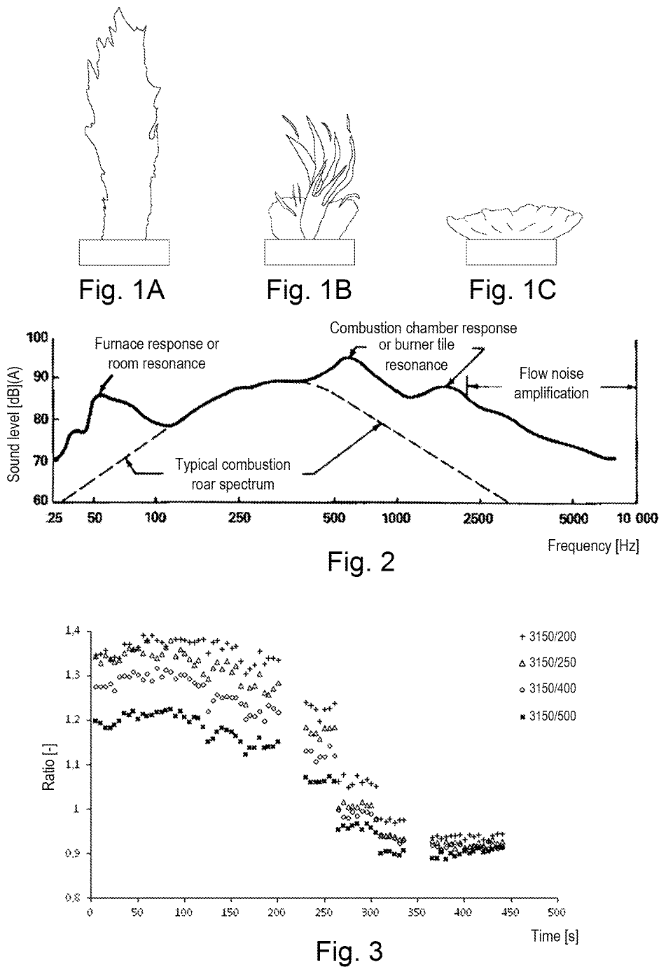

Pollutant emission regulations for heat engines, boilers, and combustion systems are continuously stringent. Nowadays, these requirements for steady-operating combustion applications are often fulfilled by using a lean mixture, using burners developed explicitly for such operation. It is known from Glassman, Yetter: “Combustion” (Burlington: Academic Press, 2008) that the lean flammability limit in terms of air-to-fuel equivalence ratio is typically the double of the stoichiometric mixture, showing marginal variations for hydrocarbon fuels. Nowadays, the most important pollutants are nitrogen oxides (NOₓ), which concentration in the flue gas is mitigated by using a leaner mixture. It is known from Dunn-Rankin “Lean Combustion: Technology and Control” (Academic Press, 2007.) that if there is excess oxygen in the combustion zone compared to the required for complete combustion, the flame temperature will be lower, ultimately leading to a reduced NOₓ emission. The leaner mixture can be characterized with a reduced flame propagation speed, however, to provide a suitably wide operating range, the flame is usually stabilized by swirl vanes. Swirling flames can be classified into strongly and weakly swirling flames, depending on the swirl intensity, discussed by Beer, Chigier “Combustion aerodynamics” (London, Robert E. Krieger Publishing Company, Inc. 1972.). While the flame shape is helical at low swirl, it forms a V shape when the swirl intensity is high. There is a transitory regime between the mentioned two, in which both straight and V-shaped flames can be observed, see Jozsa, Kun-Balog “Stability and emission analysis of crude rapeseed oil combustion” “Fuel Processing Technology”, (156, pp. 204-210. 2017.). The mentioned flame shapes are qualitatively shown in FIG. 1.

The preferred flame shape is the V since it is characterized by a notably reduced NOₓ emission. Consequently, there are numerous journal papers available in the public literature dealing with such flame shape, such as Stair, Boxx, Carter, Meier “Experimental study of vortex-flame interaction in a gas turbine model combustor” (Combustion and Flame, 159(8), pp. 2636-2649. 2012.); Durox, Moeck, Bourgouin, Morenton, Viallon, Schuller, Candel: “Flame dynamics of a variable swirl number system and instability control” (Combustion and Flame, 160(9), pp. 1729-1742. 2013.); Noiray, Denisov: “A method to identify thermoacoustic growth rates in combustion chambers from dynamic pressure time series” (Proceedings of the Combustion Institute, 36(3), pp. 3843-3850. 2017.); Idahosa, Basu, Miglani: “System Level Analysis of Acoustically Forced Nonpremixed Swirling Flames” (Journal of Thermal Science and Engineering Applications, 6(3), pp. 1-15. 2014.)

The flame shape is critical from the point of view of the operation of an engine; inappropriate design may lead to severe damage. Hence, the requirement for time-to-time or online diagnostics of the flame shape is becoming increasingly important. Such methods are used explicitly for low reaction time flame diagnostics or control.

It is known that various flame shapes feature distinct acoustic characteristics. Based on the requirements above, acoustical and mathematical investigation of flame shapes and analysis of combustion, finding the governing and modifying phenomena by control has become a highlighted research area in the past decades. This is supported by the following comprehensive publications: Huang, Y., Yang, V. “Dynamics and stability of lean-premixed swirl-stabilized combustion” (Progress in Energy and Combustion Science, 35(4), pp. 293-364. 2009.), Lieuwen, T. “Unsteady Combustor Physics” (New York, N.Y.: Cambridge University Press. 2012.), and Reed, R. J. “North American Combustion Handbook: A Basic Reference on the Art and Science of Industrial Heating with Gaseous and Liquid Fuels” (Claveland, Ohio: North American Mfg. Co. 1986.). The known flame acoustic analysis methods principally evaluate the Fourier-transform of the pressure signal, however, the spectral data is not processed further. Hence, they do not realize the goal of the present method. Nevertheless, time series analysis is another known method in the literature; this method similarly fails to provide the goals discussed earlier.

The characteristic frequencies of the combustion chamber can be well-localized; the mentioned book of Reed tells that the phenomenon of turbulent combustion can be described by broadband noise in the spectrum. A typical acoustic spectrum originated from combustion is presented in FIG. 2. Nowadays, noise analysis can be performed by a smartphone using Fourier-transform; however, the broadband characteristics of combustion provides excessive information that makes diagnostics cumbersome. Furthermore, it means an excessive amount of computational power is required for the data processing unit.

Our goal with this invention is to make simpler, more robust, and accurate determination of the identification of notable flame shapes during combustion possible.

We have recognized that in the case of a steady-operating combustion chamber, in which all three flame shapes may occur, there are such characteristic frequencies, which helps with apparently distinguishing the three flame shapes by calculating the ratio of the sound pressure levels of the nearby band center frequencies. The frequency analysis can be performed online by the currently available microphones and software.

Our goal, namely, determining the ratio of the sound pressure levels of the band center frequencies has been reached by a method according to claim 1. Several main advantageous realizations of the method are disclosed in dependent claims.

A main advantage of the method according to the invention is that a third-octave analysis can be performed online with common devices, hence microphones and widespread software. Since these frequency bands are sufficiently wide, robust diagnostics can be performed as the method is insensitive to the temporal evolution of frequency peaks. The result can be directly determined by the method according to the invention, there is no need for further technology or method.

Additional features and advantages are described herein and will be apparent from the following detailed description and the figures wherein

FIGS. 1a-1c show straight, transitory, and V-shaped flames,

FIG. 2 shows a spectral distribution of the combustion noise inside a combustion chamber,

FIG. 3 shows a spectral distribution of the combustion noise, using third-octave analysis in the case of various flame shapes,

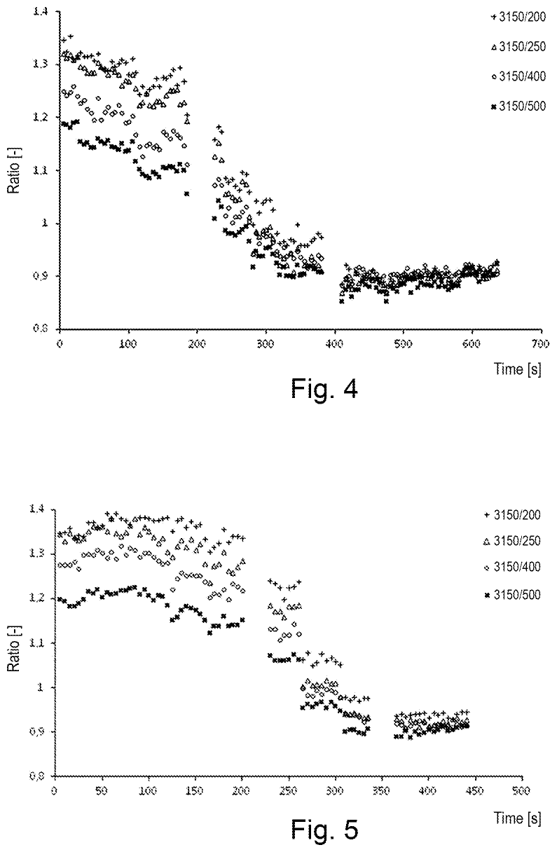

FIG. 4 shows the ratio of third-octave amplitudes by flame shapes at lower atomizing pressure, and

FIG. 5 shows the ratio of third-octave amplitudes by flame shapes at higher atomizing pressure.

FIGS. 1a-1c show the straight, transitory, and V-shaped flames, according to the known classification and characterization of flames in combustion science.

FIG. 2 qualitatively shows the spectral distribution of combustion noise in a combustion chamber, in which the dashed line represents the typical acoustic spectrum of combustion. The measured noise, indicated by the solid line, the peaks below 100 Hz are originated from the combustion chamber geometry; consequently, they depend on the chamber geometry. The energy content of the spectrum above 10 kHz is low; hence, they are less relevant from the point of view of industrial combustion chamber diagnostics. The noise originated from combustion, and the affected flow field by combustion is located between these limitations, which are in the focus of our analyses.

FIG. 3 shows that frequency components between 3 kHz and 4 kHz dominate, which continuously shifts towards the sub-1 kHz range in the transitory regime. The components above 2 kHz in the case of V-shaped flame are closely identical to the noise spectrum of the cold flow case, which is present after the flame blowout. This measurement result is in line with the published spectral data of similar burner configurations, see, e.g., Singh, A. V., Yu, M., Gupta, A. K., Bryden, K. M. “Investigation of noise radiation from a swirl stabilized diffusion flame with an array of microphones” (Applied Energy, 112, pp. 313-324. 2013).

It can be observed that the peaks are weakly localized in the spectral regimes, and the changing of the acoustic impedance also means temporal variation, described by, e.g., Kabiraj, L., Sujith, R. I. “Nonlinear self-excited thermoacoustic oscillations: intermittency and flame blowout” (Journal of Fluid Mechanics, August 2015, pp. 1-22. 2012) and Sampath, R., Chakravarthy, S. R. “Investigation of intermittent oscillations in a premixed dump combustor using time-resolved particle image velocimetry” (Combustion and Flame, 172, pp. 309-325. 2016).

These public sources are also supporting that the researchers try to make conclusions on flame shapes based on the detailed frequency regime, which makes the above-detailed excessive effort essential, and confines the available information for further processing.

Taking apart from this well-established, common practice a new method has been developed in which sound pressure levels of various frequency intervals are investigated at various spectral bands instead of using a detailed frequency resolution. Third-octave analysis is a possible method, which, however, contains frequency resolution detailed in the ISO 18405:2017 standard, its intentional use in practical combustion was not published according to our best knowledge, and also, its use was not discussed anywhere as a possibility.

In the following example, there were five third-octave bands identified, originated from measurement results for maximum efficiency. However, if the spectrum of a similar burner to the subject one is known, then a prediction can also be performed, which might work without correction based on the experimental results, but it is strongly advised.

A lean premixed prevaporized burner is analyzed as an example to the application of the present invention, in which the combustion air inlet had a tangential component, making the flow swirling. For the analysis, there must be at least one sensor put into the combustion chamber, which is capable of sensing combustion noise, hence, the acoustic fluctuations created by combustion. Such a sensor can be, e.g., a pressure sensor or a microphone, which is sensitive in the above-detailed spectral range; hence, its output signal can be used for further processing.

The sampling frequency of the microphone, used as a pressure sensor, should be at least double of the largest frequency component, like in the present case, according to the Nyquist-Shannon sampling theorem; however, a factor of three to five is recommended in practice. Consequently, using at least 10 kHz sampling frequency is advised. It should be noted that most of the commercially available noise analyzer systems operate at 20 kHz by default; hence, the application of this method can be performed by an expert in a familiar environment; it does not require special, expensive technology. Combustion noise at lower frequencies is not compact; consequently, it cannot be assumed as a point source. However, the location of the microphone is limited by practical reasons as the device may defect at high temperatures. To enhance its thermal resistance capability, a cooled sensor socket can be used if the operating temperature given by the manufacturer of the microphone cannot be met by proper placement. In the presented example, the microphone was placed at the height of the burner lip, 1 m sideways. Nevertheless, this is not possible in the case of an industrial application. Hence, by knowing the propagation of the noise, one should select a sensor with the right sensitivity. The noise inside the flame maybe 150-170 dB in the case of industrial burners, while this is 50-70 dB in the case of domestic appliances. The decrease of noise intensity is quadratic as the function of the distance measured from the source in the case of free noise propagation. Fundamentally, combustion noise shows low directional dependence; hence, the placement of the sensor is nearly arbitrary. The data are evaluated by the aforementioned third-octave method, provided by the ISO 18405:2017 standard.

The measurement can be performed from time-to-time, however, for maximum efficiency, continuous data evaluation is recommended.

To identify the characteristic frequency bands, a few different operating conditions are set to analyze the flame spectrum within the boundaries of physically possible parameter ranges given by the burner. The system incorporating the burner determine a minimum and maximum airflow rate, the fuel system sets an upper limit of thermal power, and the air delivery system with the swirl vanes limits the range of possible swirl numbers. During our investigation, the notable regimes are selected, and the analysis is performed on these.

The various frequency bands are respective to the burner design. For instance, in the case of the burner taken as an example, the third-octave band center frequencies were 200, 250, 400, 500, and 3150 Hz. However, these frequencies depend on burner design, similar values were expected, based on, e.g., Singh, A. V. et al. “Investigation of noise radiation from a swirl stabilized diffusion flame with an array of microphones” and Candel, S., Durox, D., Schuller, T., Bourgouin, J.-F., Moeck, J. P. “Dynamics of Swirling Flames” (Annual Review of Fluid Mechanics, 46(1), pp. 147-173. 2014).

FIGS. 4 and 5 show the results of the third-octave evaluation of the spectral analysis. The resulting ratio of sound pressure levels were indicated for various operation setups. FIG. 4 shows the ratio of the third-octave amplitudes, separated by flame shape for a lower, 0.83 bar atomizing gauge pressure; FIG. 5 shows the ratio of the third-octave amplitudes at a higher, 1.55 bar atomizing gauge pressure. The time was put on the horizontal axis, and the ratio of the sound pressure levels of third-octave bands can be seen on the vertical axis. The presented measurement runs show the temporal increase of the combustion air flow rate up to flame blowout. The notation in the legend is respective to the band center frequencies of the third-octave analysis method. The first regime on the left is respective to the straight flame, and the regime on the right is respective to the V-shaped flame. The regime between them indicated the transitory state. The stair-like temporal signal is due to the measurement protocol: a single setup was held for at least 30 s to capture the respective acoustic characteristics in an adequate detail.

The sound pressure level ratio of straight and V-shaped flames notably differs. It was shown in FIG. 4 that the flame is straight up to 200 s, the transitory behavior is between 200 and 400 s, and a V-shaped flame is present from 400 s. The ratio above unity refers to that the sound pressure level at 3150 Hz is greater than each of that at 200, 250, 400, and 500 Hz in the spectrum. However, this rends reverses for V-shaped flames, and the sound pressure level at 3150 Hz suppresses. Hence, following this simple data reduction technique, anyone at the site can get into a result by using a simple division from the results of continuous measurement. Band center frequencies of 250 and 400 Hz were the results from an extensive analysis on a wide range of setups, using this technique since they were similarly local maxima.

It can be seen that the sound pressure level ratios are nearly identical. A similar trend characterized V-shaped flames, while there is a continuous transition in the transitory state. Based on this ratio, we can properly determine the flame shape and use this information for creating control algorithms if the combustion system characteristics are now.

The method can be used for measurement by the third-octave method, and the results can be stored within the physically possible operation range of a burner, where combustion can be sustained. Typically, we can go beyond the factory limitations, which might mean less favorable operation. Based on the diagram of FIG. 4, we can determine the notable frequency peaks corresponding to a single operating point. A possible procedure for this is checking if the current sound pressure level is higher than the two adjacent ones in both directions. If not, we can proceed. Based on this algorithm, the local peaks can also be localized beside the global ones, making them together the band center frequencies to check.

It should be noted that even the name of the third-octave method refers to the fact that the spectrum is analyzed in bands, more precisely, in logarithmic order. Hence, the spectral resolution is not perfect; the sound pressure level is corresponding to a broader band. However, combustion is a broadband phenomenon. Therefore this simplification does not lead to the loss of information. The first band center frequency that meets the above-detailed condition is 200 Hz, 500 Hz, and 6300 Hz for V-shaped flames, as it is known from the ISO 18405:2017 standard. Based on our combustion-related experiences, the last identified peak is an outlier since there is no such characteristic frequency as all the significant frequency components were below 6 kHz. Consequently, the third result was omitted. Nevertheless, precision would require the use of 6.3 kHz; the 300 Hz difference does not mean deviation in practice due to the logarithmic nature of the third-octave frequencies. The 6 kHz limitation was determined by the Fourier-transform technique since only background noise can be found from this frequency up to 20 kHz. In conclusion, there is no need to check higher frequency ranges.

The first local peak for straight flames is located at 500 Hz, then at 3150 Hz, which is also the global maximum. Since the spectra of both the straight and the V-shaped flame appears in the spectra of transitory flames hence, the following frequency peaks were found: 500 Hz, which was already present for both straight and V-shaped flames, and 3150 Hz, which was the global peak of the straight flame. Also, there was a local maximum located at 16 kHz, however, it was omitted due to the above reasons.

The method presented in the above example can be used for all spectra. It is possible that both the number and frequency of the detected notable peaks vary within a single flame shape as the operating conditions change. If there are technically relevant criteria for the burner to meet, such as pollutant emission, these data should be evaluated along with the spectra. The flame shape should be generally understood as a parameter range in which there is no sudden jump in the characterizing properties, meaning even favorable or unfavorable conditions. The sudden jump can be defined here as a 10% change in a single parameter on a relative scale. Following this, it is possible to find multiple characteristic regimes in the case of a single combustion chamber for, e.g., uniformly V-shaped flames. It should be noted that this method also works for combustion chambers that do not feature V-shaped flame.

It should be highlighted that a flame can be of any physical shape; the distinction between flame shapes should be made based on their behavior since their visible appearance might be similar. Therefore, it might be beneficial to provide optical access to the flame during the measurement procedure to see the flame structure; having such access is not mandatory but greatly helps the processing of measurement data. Finally, the number of the monitored frequencies and the relevant frequency ratios should be determined in a way to have a correlation with the notable characteristic parameter or parameters of the flame. For instance, these can be pollutant emissions or system efficiency.

A person skilled in the art may gather the same information by using a technique other than the above-detailed third-octave method. The information content of the evolution of the frequency ratios may be derived by using another spectral resolution technique, consequently, the third-octave approach is only a possible solution that can be used. In other cases, an octave-based, coarser approach and finer spectral resolution than that offered by the third-octave method can also lead to success.

A further possible approach, different from the detailed above, is the adaptive parameter analysis by using Artificial Intelligence. During this process, the system response to the change of the substantial parameters is investigated. Based on the results, a ‘learning database’ is created, then the correlation model is tested on data outside of the learning database. By using this approach, the same result can be achieved as detailed above, not necessarily relying on acoustical data. This technique is usually less favorable in industrial applications since its operation is not transparent, and the generated database by machine learning is not well-defined and not searchable for the operator. The statistical nature of this technique usually means an excessive risk for critical areas; hence, they are seldom used.

1. A method of determining the flame shape of swirling flame of a burner in a steady-operating closed combustion chamber,
in which
the broadband combustion noise is sensed by a sensor in acoustic connection with the combustion chamber,
the frequency spectrum and the sound pressure level are determined from the acoustic oscillations originated from combustion noise,
the flame shape is determined from the spectrum and the sound pressure levels characterized in that
the notable frequency bands are identified by evaluating the flame spectrum at various operating conditions by continuously adjusting at least one of the fuel mass flow rate, combustion air flow rate, and swirl number in the physically accessible operating range.
The frequency spectrum is divided into 0-500 Hz, 501-2000 Hz, and 2-6 kHz ranges, and the amplitudes at the band center frequencies are determined, and
based on the band center frequency,
the temporal evolution of the band center frequencies separately
the evaluation of the ratio of the band center frequencies
or the combination of the two
the shape of the swirling flame is calculated.

2. The method of claim 1, characterized in that the spectral range decomposition is performed by closely the third-octave series.

3. The method of claim 1, characterized in that the spectral range decomposition is performed by octave series.

4. The method of claim 1, characterized in that the band center frequency describing the straight flame is defined and analyzed within a range of 1 kHz and 5 kHz, and the band center frequency describing the V-shaped flame is defined and analyzed below 500 Hz.

5. The method of claim 2, characterized in that the band center frequency describing the straight flame is defined and analyzed within a range of 1 kHz and 5 kHz, and the band center frequency describing the V-shaped flame is defined and analyzed below 500 Hz.

6. The method of claim 3, characterized in that the band center frequency describing the straight flame is defined and analyzed within a range of 1 kHz and 5 kHz, and the band center frequency describing the V-shaped flame is defined and analyzed below 500 Hz.
